(19) United States
(12) Patent Application Publication
(10) Pub. No.: US 2022/0180180 A1
(43) Pub. Date: Jun. 9, 2022

(54) DATA-DRIVEN NEURAL NETWORK MODEL COMPRESSION

(71) Applicant: International Business Machines Corporation, Armonk, NY (US)

(72) Inventors: Tong Liu, Xi'an (CN); Zhong Fang Yuan, Xi'an (CN); Kun Yan Yin, Ningbo (CN); He Li, Beijing (CN); Li Juan Gao, Xian (CN)

(21) Appl. No.: 17/115,857

(22) Filed: Dec. 9, 2020

(51) Int. Cl. G06N 3/08; G06N 3/04

(52) U.S. Cl. CPC G06N 3/08; G06N 3/0454

(57) ABSTRACT

A data-driven model compression technique is introduced that only targets to provide same accuracy as the original (not compressed) model in certain areas by reducing compression parameters. A compression engine relies on backpropagation to determine an extent of parameter value changes and designate certain parameters as key parameters. The model matrix is reshaped according to importance of each neuron. Only randomly generated parameter values of the reshaped parameter matrix are fine tuned to create a reliable compressed neural network model.

### BACKGROUND

The present invention relates generally to the field of neural networks, and more particularly to model compression. Pretrained deep learning language models such as BERT (Bidirectional Encoder Representations from Transformers), ENTIRE, and GPT (Generative Pre-trained Transformer) are known for excellent accuracy when compared to traditional models.

In the research community as well as in enterprise IT (information technology) organizations, AI (artificial intelligence) and machine learning are currently at the edge of becoming a mainstream technology. Several approaches have been applied as effective tools for machine learning. For a certain class of problems, artificial neural networks (ANN) or deep neural networks (DNN) may be well suited as technical architecture to support artificial intelligence applications.

Neural networks require training, which may be supervised, semi-supervised or, unsupervised, before they are used for inference tasks such as classification or prediction. Typically, today, supervised learning techniques are used which may require a plurality of annotated training data. Backpropagation is currently the most used algorithm for training deep neural networks in a wide variety of tasks.

Compressing a neural network by updating weight values in the compressed layers is known. The processes may include replacing at least one layer in the neural network with multiple compressed layers to produce a compressed neural network; inserting non-linearity between the compressed layers of the compressed neural network; and fine-tuning the compressed neural network by updating weight values in at least one of the compressed layers.

Pruning and distillation-based convolutional neural network (CNN) compression is known. The processes may include fine-tuning a CNN model to restore its accuracy; using a distillation method to extract the knowledge in the original CNN model into the compression model to improve its performance; and, in distillation, making the output of the pruned model network fit the output of the large network to achieve the purpose of distillation during training.

### SUMMARY

In one aspect of the present invention, a method, a computer program product, and a system includes: (i) monitoring parameter values of a neural network parameter matrix while training a neural network model; (ii) identifying a set of key parameters of the neural network parameter matrix based on parameter value changes during the training; (iii) creating a compressed neural network model by including only key parameters from the neural network parameter matrix; and (iv) fine tuning only randomly generated parameter values of the compressed neural network model to generate a final compressed model.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a flowchart view of a second embodiment of a method according to the present invention; and

FIGS. 5A, 5B, and 5C are matrix views showing information that is generated by and/or helpful in understanding embodiments of the present invention.

### DETAILED DESCRIPTION

A data-driven model compression technique is introduced that only targets to provide same accuracy as the original (not compressed) model in certain areas by reducing compression parameters. A compression engine relies on backpropagation to determine an extent of parameter value changes and designate certain parameters as key parameters. The model matrix is reshaped according to importance of each neuron. Only randomly generated parameter values of the reshaped parameter matrix are fine tuned to create a reliable compressed neural network model.

The term “neural network” (NN) may denote a brain inspired network of nodes and connections between the nodes which may be trained for inference in contrast to procedural programming. The nodes may be organized in layers and the connections may carry weight values expressing a selective strength of a relationship between selected ones of the nodes. The weight values define the parameters of the neural network. The neural network may be trained with sample data for, e.g., for a classification of data received at an input layer of the neural network, wherein the classification results together with a confidence values can be made available at an output layer of the neural network. A neural network comprising a plurality of hidden layers (in addition to the input layer and the output layer) is typically denoted as deep neural network (DNN).

The term “importance value” may denote a numerical value assigned to a selected node in a selected layer of the neural network. In one embodiment, it may be derivable as the sum of all weight values—or, e.g., its absolute (math. sense) values—of incoming connections to the selected node. In an alternative embodiment, it may be the sum of weight values of all outgoing connection of the node. In general, the higher the sum of the absolute weight values, the greater the importance. It may also be seen as a responsibility of a specific node for influencing a signal traveling from the input layer to the output layer through the NN.

The term “backpropagation” (BP) may denote the widely used algorithm in training feedforward neural networks for supervised learning. In fitting—i.e., training—the neural network, the backpropagation method determines the gradient of the loss function with respect to weight values of the NN for a single (or a plurality) of input-output training data. In general, the back propagation algorithm may work by determining the gradient of the loss function with respect to each weight by the chain rule, determining the gradient one layer at a time, iterating backwards from the last NN layer to avoid redundant calculations of intermediate terms in the chain rule.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

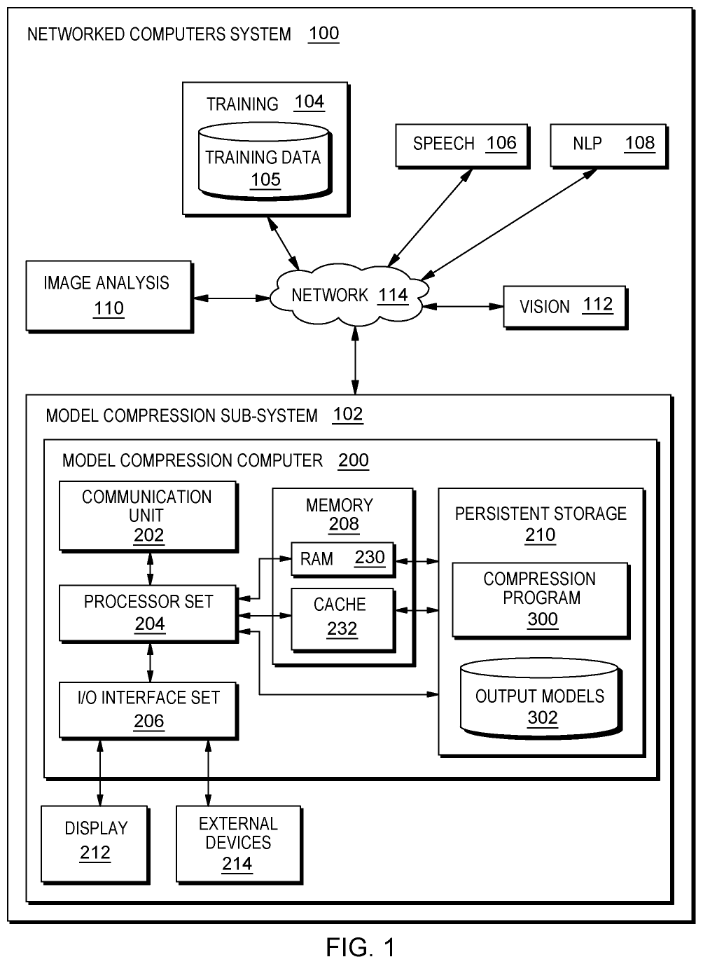

The present invention will now be described in detail with reference to the Figures. FIG. 1 is a functional block diagram illustrating various portions of networked computers system 100, in accordance with one embodiment of the present invention, including: model compression sub-system 102; training sub-system 104; speech sub-system 106; natural language processing (NLP) sub-system 108; image analysis sub-system 110; vision sub-system 112; communication network 114; model compression computer 200; communication unit 202; processor set 204; input/output (I/O) interface set 206; memory device 208; persistent storage device 210; display device 212; external device set 214; random access memory (RAM) devices 230; cache memory device 232; model compression program 300; and final output models store 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Model compression program 300 operates to compress a neural network model and to refine the compressed model based on randomly generated parameters in the compressed model. Selection of key model parameters, identifying randomly generated parameters, and fixing the values of non-randomly generated parameters are example steps taken by the model compression program according to some embodiments of the present invention.

Some embodiments of the present invention recognize the following facts, potential problems and/or potential areas for improvement with respect to the current state of the art: (i) pretrained deep learning models focus on covering data from many areas or fields during the training phase so the trained models require numerous input parameters, have a high demand hardware resources, and have a poor response time in practice; and/or (ii) for scenarios having limited system resource availability or that require low response times, existing pretrained deep learning models are not a good choice.

By the feature of backpropagation, values of parameters in a neural network will change during training, if a parameter value changes a lot relative to other parameter values, the corresponding parameter may be a useful parameter in the training process. Such a parameter is referred to herein as a “key parameter” for a given neural network model. Accordingly, only key parameters are used in the compressed model and other parameters are not included.

Some embodiments of the present invention operate to reshape the parameter matrix from N×M to N×M×2. Further, adding an additional flag for each parameter in the parameter matrix for recording parameter value changes for each parameter during the training process. When the neural network model is trained using field data, every neuron is sorted by degree of importance. With reference to the degree of importance a determination is made as to which neurons should be removed from the neural network model to create a resulting compressed, or relatively smaller, neural network model.

When the original neural network model is compressed as stated above, the output is the compressed model along with some randomly generated parameters. With a focus on keeping the accuracy and generalization of the compressed model at a predefined level for acceptability, parameters of the compressed model that are not randomly generated are fixed and the randomly generated parameters are fine-tuned by training data. Because the training parameters in this scenario are relatively few, the training process is relatively shorter than if the compressed model with all variable parameters were trained. When the fine-tuning training is complete, the output model is the final compressed model.

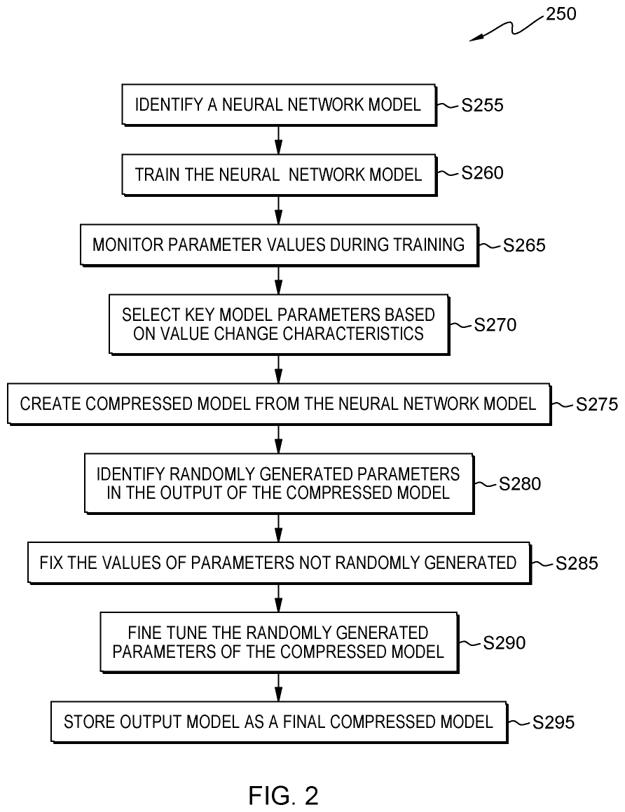

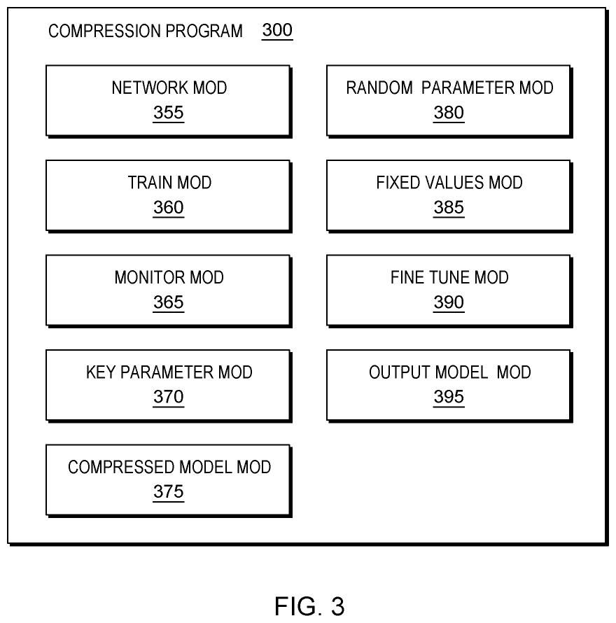

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where network module (“mod”) 355 identifies a neural network model for use in a model compression process as discussed below.

Processing proceeds to step S260, where train mod 360 trains the identified neural network model. In this example, training data is retrieved from training data store 105 of training sub-system 104 (FIG. 1). During training the principle of backpropagation certain parameter values, or weights, will change. Those parameter values having a relatively high change activity have been recognized as being more useful parameters than those whose values do not changes as significantly.

Processing proceeds to step S265, where monitor mod 365 monitors parameter values during training. Monitoring the weights provides the basis for identifying key parameters. When training using field data, the network model the parameter matrix is reshaped from N×M to N×M×2. A flag for each parameter records the value changes or changes in weight. In this example, the monitoring step includes recording parameter values over time. Alternatively, changes in parameter values are recorded as a percentage change over time. Alternatively, for every parameter value change the monitor module begins independently tracking the changes in value of the corresponding parameter.

Processing proceeds to step S270, where key parameter mod 370 selects key parameters based on value change characteristics. As stated above, every neuron in the network model is sorted by degree of importance. With reference to the degree of importance a determination is made as to which neurons should be removed from the neural network model to create a resulting compressed, or relatively smaller, neural network model. In this example, value change characteristics are the change in values over time. Alternatively, the percentage change in value is the value change characteristic of interest. Further, in order to designate a parameter and a key parameter, the parameter value must meet a threshold level of change regardless of the particular characteristic being monitored.

Processing proceeds to step S275, where compressed model mod 375 creates a compressed model from the identified neural network model. The compressed model is created by removing neurons associate with parameters not identified as key parameters.

Processing proceeds to step S280, where random parameter mod 380 identifies randomly generated parameters in the output of the compressed model. When the compressed model is created some parameters of the model are randomly generated. Those parameters that are randomly generated from the compressed model are identified for use when find-tuning the model as discussed below.

Processing proceeds to step S285, where fixed values mod 385 fixes the values of parameters not randomly generated by the compressed model. By fixing these parameter weights, the next phase of compression operates only on the randomly generated parameter weights.

Processing proceeds to step S290, where find tune mod 390 find tunes the randomly generated parameters of the compressed model. The randomly generated parameter weights are fine-tuned by training data to completion. In some embodiments the parameters are tuned to convergence.

Processing ends at step S295, where final output model mod 395 stores the output model as a final compressed model. In this example, the final output model is stored in output models store 302 for use by client sub-systems such as image analysis sub-system 110 (FIG. 1).

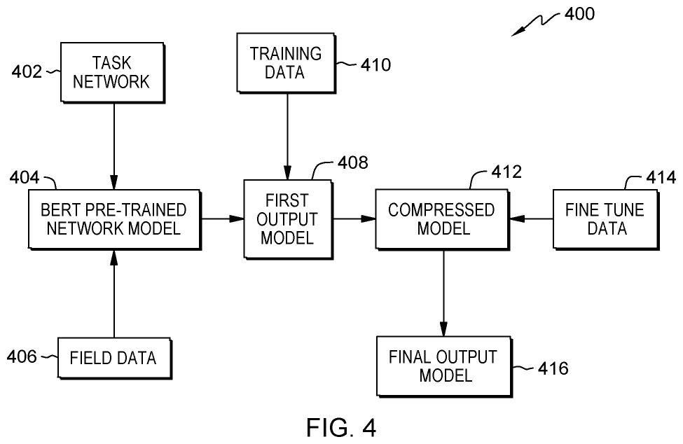

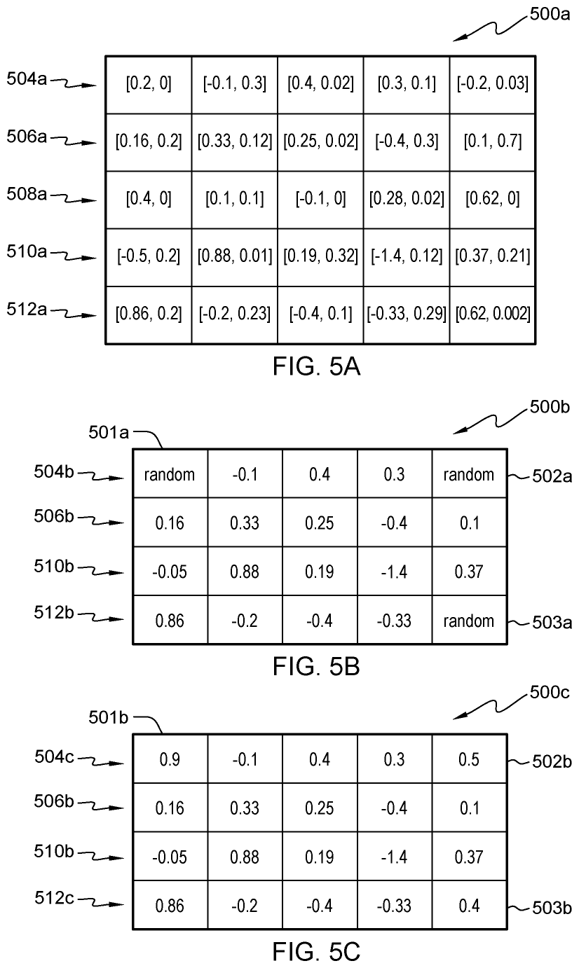

Further embodiments of the present invention are discussed in the paragraphs that follow and later with reference to FIGS. 4 and 5.

Some embodiments of the present invention are directed to model compression via parameter matrix compression based on specific data. The disclosed data-driven intelligent deep neural network (DNN) model compression is different from other attempts at model compression in that the data-driven intelligent DNN model compression is suitable for all downstream sub-tasks with fewer compression parameters and improved performance metrics.

Some embodiments of the present invention are directed to compression of a large deep-learning natural language model based on specific data corpus.

Some embodiments of the present invention are directed to compressing a pre-trained DNN model. More specifically, some embodiments of the present invention compress the neural network model by compressing the parameter vectors, then using the specific data corpus to perform fine-tuning on the compressed model resulting in performance similar to un-compressed DNN model.

FIG. 4 shows flowchart 400 depicting a second method according to an embodiment of the present invention. FIGS. 5A, 5B, and 5C illustrate parameter matrix changes during model compression performed by at least some of the method steps of flowchart 400. This method and associated matrices will now be discussed, over the course of the following paragraphs, with extensive reference to FIG. 4 (for the method step blocks). The second method illustrated in flowchart 400 may be implemented similar to the operations of compression program 300 discussed above with respect to flowchart 250.

Processing begins at step 402, where a task network is identified for pre-training according to the deep learning language model BERT (Bidirectional Encoder Representations from Transformers).

Processing proceeds to step 404, where the BERT pre-trained network model is generated for compression. Pre-training is performed using field data 406. FIG. 5A shows parameter matrix 500a for the BERT pre-trained network model including neurons represented by rows 504a, 506a, 508a, 510a, and 512a.

Processing proceeds to step 408 where the first output model is created from the BERT pre-trained model. The first output model is compressed by reshaping the parameter matrix and adding an additional flag for each parameter in the parameter matrix for recording parameter value changes for each parameter during the training process. In this example, the reshaping process is depicted in FIG. 5B as parameter matrix 500b which is modified from matrix 500a by removing neuron 508a because it has the most randomly generated parameter weights. A total of three parameter values are randomly generated in row 508a shown as [0.4, 0], [−0.1, 0], and [0.62, 0]. Other neurons having randomly generated values include neuron 504a shown as [0.2, 0] and [−0.02, 0.03] and neuron 512a shown as [0.62, 0.002]. While training the BERT model on training data 410, the parameter values changes are monitored to identify key parameters according to their degree of importance.

Processing proceeds to step 412, where a compressed model of the first output model is created by including only certain parameters identified as key parameters during the training process of step 408. The new matrix for the compressed model is illustrated in FIG. 5B. When a parameter value changes significantly relative to other parameter values during the training process, the corresponding parameter is referred to as a key parameter. In this example, row 504b has two randomly generated parameter weights 501a and 502a. Row 512b has one randomly generated parameter weight 503a. All other parameter weights are fixed for remaining rows 506b and 510b

Processing ends at step 416, where the final output model is generated by fine tuning the compressed model with fine tuning data 414. The weights of the randomly generated parameters in the compressed model are fine tuned while parameters that were not randomly generated are assigned a fixed weight. The fine-tuned matrix for the final output model is illustrated in FIG. 5C. The fine-tuned weights are fixed values in the final output model shown as parameter matrix 500c including fixed weights in row 504c depicted at cells 501b and 502b and in row 512c depicted at cell 503b. The final output model is a fine-tuned model for use in the particular area in which it was trained.

Some embodiments of the present invention were tested according to a model compression method described herein based on a question-matching task. The results are shown in Table 1 along with comparisons to other model compression techniques. The Bert-trained model in the natural language processing area is treated as the original model and a large-scale Chinese question matching corpus (LCQMC) dataset is used as field data.

Table 1 compares results of a compressed model according to embodiments of the present invention with three other neural network models: (i) a BERT-trained model; (ii) an ALBERT model (a popular compressed BERT model); and (iii) a traditional training model without BERT pre-training.

TABLE 1
Comparison of test results using various neural network models.

| | MODEL | INFERENCE | | | |
|---|---|---|---|---|---|
| | SIZE | TIME | ACCURACY | RECALL | F-1 |
| MODEL | (Mb) | (MS/ITEM) | (%) | (%) | (%) |
| BERT- | 783 | 301 | 93.4 | 90.5 | 91.2 |
| Trained | | | | | |
| Model | | | | | |
| Example | 23 | 29 | 93.2 | 90.4 | 91.6 |
| Embodiment | | | | | |
| Model | | | | | |
| ALBERT | 27 | 26 | 89.3 | 88.5 | 88.7 |
| Model | | | | | |
| CNN Model | 21 | 18 | 81.5 | 82.8 | 81.6 |
| without | | | | | |
| BERT Pre- | | | | | |
| training | | | | | |

The result shows, the example embodiment compressed model, is 1/39 the size of the original BERT-trained model for the question-matching task. The prediction speed of the example embodiment compressed model is 10 times that of the BERT-trained model. Further, the example embodiment compressed model works almost the same as the original model. It should be noted that some of test results exceeded the performance of the original model.

Some embodiments of the present invention may include one, or more, of the following features, characteristics and/or advantages: (i) increases the performance of the compressed model without losing too much accuracy; and/or (ii) based on domain data-driven, compresses a very large deep original model; (iii) responds quickly without affecting accuracy in specific areas.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for compressing a neural network parameter matrix, the method comprising:
monitoring parameter values of a neural network parameter matrix while training a neural network model;
identifying a set of key parameters of the neural network parameter matrix based on parameter value changes during the training;
creating a compressed neural network model by including only key parameters from the neural network parameter matrix; and
fine tuning only randomly generated parameter values of the compressed neural network model to generate a final compressed model.

2. The method of claim 1, wherein the neural network model is a pre-trained bidirectional encoder representations from transformers (BERT) model.

3. The method of claim 1, wherein creating the compressed neural network model includes:
identifying randomly generated parameters in the neural network parameter matrix; and
reshaping the neural network parameter matrix by removing neurons having a maximum count of randomly generated parameter values.

4. The method of claim 3, wherein the reshaping the neural network parameter matrix reshapes the neural network parameter matrix from an N×M matrix to an N×M×2 matrix.

5. The method of claim 1, wherein the parameter value changes are significant relative to other parameter value changes within the neural network parameter matrix.

6. The method of claim 1, further comprising:
adding a flag for each parameter in the neural network parameter matrix, the flag recording the parameter value changes during the training of the neural network model;
wherein:
the recorded parameter value changes are the basis for identifying the set of key parameters of the neural network parameter matrix.

7. A computer program product comprising a computer-readable storage medium having a set of instructions stored therein which, when executed by a processor, causes the processor to compress a neural network parameter matrix by:
monitoring parameter values of a neural network parameter matrix while training a neural network model;
identifying a set of key parameters of the neural network parameter matrix based on parameter value changes during the training;
creating a compressed neural network model by including only key parameters from the neural network parameter matrix; and
fine tuning only randomly generated parameter values of the compressed neural network model to generate a final compressed model.

8. The computer program product of claim 7, wherein the neural network model is a pre-trained bidirectional encoder representations from transformers (BERT) model.

9. The computer program product of claim 7, wherein creating the compressed neural network model includes causing the processor to compress a neural network parameter matrix by:
identifying randomly generated parameters in the neural network parameter matrix; and
reshaping the neural network parameter matrix by removing neurons having a maximum count of randomly generated parameter values.

10. The computer program product of claim 9, wherein the reshaping the neural network parameter matrix reshapes the neural network parameter matrix from an N×M matrix to an N×M×2 matrix.

11. The computer program product of claim 7, wherein the parameter value changes are significant relative to other parameter value changes within the neural network parameter matrix.

12. The computer program product of claim 7, further causing the processor to compress a neural network parameter matrix by:
adding a flag for each parameter in the neural network parameter matrix, the flag recording the parameter value changes during the training of the neural network model;
wherein:
the recorded parameter value changes are the basis for identifying the set of key parameters of the neural network parameter matrix.

13. A computer system for compressing a neural network parameter matrix, the computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to compress a neural network parameter matrix by:
monitoring parameter values of a neural network parameter matrix while training a neural network model;
identifying a set of key parameters of the neural network parameter matrix based on parameter value changes during the training;
creating a compressed neural network model by including only key parameters from the neural network parameter matrix; and
fine tuning only randomly generated parameter values of the compressed neural network model to generate a final compressed model.

14. The computer system of claim 13, wherein the neural network model is a pre-trained bidirectional encoder representations from transformers (BERT) model.

15. The computer system of claim 13, wherein creating the compressed neural network model includes causing the processor to compress a neural network parameter matrix by:
identifying randomly generated parameters in the neural network parameter matrix; and
reshaping the neural network parameter matrix by removing neurons having a maximum count of randomly generated parameter values.

16. The computer system of claim 15, wherein the reshaping the neural network parameter matrix reshapes the neural network parameter matrix from an N×M matrix to an N×M×2 matrix.

17. The computer system of claim 13, wherein the parameter value changes are significant relative to other parameter value changes within the neural network parameter matrix.

18. The computer system of claim 13, further causing the processor to compress a neural network parameter matrix by:
adding a flag for each parameter in the neural network parameter matrix, the flag recording the parameter value changes during the training of the neural network model;
wherein:
the recorded parameter value changes are the basis for identifying the set of key parameters of the neural network parameter matrix.
